(19) United States
(12) Patent Application Publication
(10) Pub. No.: US 2024/0402775 A1
(43) Pub. Date: Dec. 5, 2024

(54) METHOD FOR CONTROLLING TOTAL POWER CONSUMPTION OF SYSTEM BY SETTING CONTROLLER PARAMETERS BASED ON TEMPERATURE DIFFERENCE

(71) Applicants: INVENTEC (PUDONG) TECHNOLOGY CORPORATION, Shanghai (CN); INVENTEC CORPORATION, Taipei (TW)

(72) Inventors: BIAO LI, Shanghai (CN); LIAN-FEI ZHANG, Shanghai (CN)

(21) Appl. No.: 18/220,286

(22) Filed: Jul. 11, 2023

(30) Foreign Application Priority Data
Jun. 1, 2023 (CN) 202310644792.5

(51) Int. Cl. G06F 1/26

(52) U.S. Cl. CPC G06F 1/26

(57) ABSTRACT

A method for controlling total power consumption of system by setting controller parameters based on temperature difference is provided, which is applied to a system at least including heat-generating element, fan, and controller, the heat-generating element having setpoint temperature Tsp. The method includes: setting the controller with a first control parameter and a second control parameter; reading a current temperature T(i) of the heat-generating element by the controller; and comparing the current temperature T(i) and the setpoint temperature Tsp by the controller to determine whether a feedback control is provided to the fan by the controller based on the first control parameter or the second control parameter such that a total power consumption of the system is controlled.

This application claims priority under 35 U.S.C. § 119 to Chinese Patent Application No. 202310644792.5, filed on Jun. 1, 2023, the entire content of which is incorporated herein in its entirety.

### TECHNICAL FIELD

The present application relates to a method for controlling total power consumption of a system by setting controller parameters based on temperature difference, and more particularly relates to a method, which has two sets of different control parameters and determines which set of control parameters to use by comparing a temperature difference, for controlling total power consumption of the system.

### BACKGROUND

In general, in the existing technologies, an overall server system needs to undergo a test on temperature and total power consumption of the overall system and so on under a designated specific environment and condition. The overall server system is configured internally to include at least the following devices: a central processing unit (CPU), a memory, a hard disk, a network card, a graphics processing unit (GPU), and the like. In addition, in one scenario of actual test, it is required that, under an environmental temperature of 25° C. for the overall system, instantaneous maximum total power consumption of the overall system is measured to be no more than 900 W.

For a condition under which an environmental temperature is 25° C., a setpoint (SP in abbreviation) temperature Tsp for safe operation of the graphics processing unit is 72° C., and a loading pressure is continuously increased from 10% to 100%, with one set of result obtained by performing a test for every 10% increment in the loading pressure. Duration of a single test is 20 minutes. Test results show that total power consumption of the overall system in a stable phase is less than 870 W. However, there are multiple power consumption peaks of the overall system, and a maximum transient power consumption pertaining to these peaks reaches 930 W, which is significantly higher than the total power consumption 900 W set for the overall system in the stable phase. In order to satisfy the requirement that the transient total power consumption does not exceed 900 W, it is necessary to eliminate these power consumption peaks of the overall system.

### SUMMARY

In view of the prior art, total power consumption of an overall system may generate multiple power consumption peaks, which is unstable. Therefore, obtaining relatively stable total power consumption of the overall system has become an urgent issue needs to be resolved.

To resolve the problem of the prior art, an essential technical measure adopted by the present disclosure is to provide a method for controlling total power consumption of system by setting controller parameters based on temperature difference, which is applied to a system with at least one heat-generating element, one fan, and one controller, where the heat-generating element has a setpoint temperature Tsp. The method includes: setting the controller with a first control parameter and a second control parameter; reading a current temperature T(i) of the heat-generating element by the controller; and comparing the current temperature T(i) and the setpoint temperature Tsp by the controller to determine whether a feedback control is provided to the fan by the controller based on the first control parameter or the second control parameter such that a total power consumption of the system is controlled.

According to an auxiliary technical measure derived from the above-mentioned essential technical measure, a step is further included: determining whether to launch a PID speed control strategy by the controller.

According to an auxiliary technical measure derived from the above-mentioned essential technical measure, during the step of comparing temperatures, when a difference between the current temperature T(i) and the setpoint temperature Tsp is relatively small, using the first control parameter; when the difference between the current temperature T(i) and the setpoint temperature Tsp is relatively large, using the second control parameter. The first control parameter is smaller than the second control parameter.

According to an auxiliary technical measure derived from the above-mentioned essential technical measure, during the step of comparing temperatures, when the difference between the current temperature T(i) and the setpoint temperature Tsp is smaller or equal to 2, using the first control parameter; when the difference between the current temperature T(i) and the setpoint temperature Tsp is greater than 2, using the second control parameter.

In view of the above, since the method for controlling total power consumption of system by setting controller parameters based on temperature difference is a method, which has two sets of different control parameters and determines which set of control parameters to use by comparing a temperature difference, for controlling total power consumption of the system, the present disclosure is able to effectively achieve relatively stable total power consumption of the system.

Specific embodiments adopted by the present disclosure are further illustrated in accordance with the following embodiments and accompanying drawings.

### BRIEF DESCRIPTION OF THE DRAWINGS

FIG. 1 shows a flow chart of a method for controlling total power consumption of a system by setting controller parameters based on temperature difference according to a preferred embodiment of the present disclosure; and

FIG. 2 shows a schematic diagram of a structure for implementing a method for controlling total power consumption of a system by setting controller parameters based on temperature difference according to a preferred embodiment of the present disclosure;

### DESCRIPTIONS OF REFERENCE NUMERALS ARE AS FOLLOWS

10: element;
20: baseboard management controller;
21: input unit;
22: storage unit;
23: calculation unit;
24: output unit;
30: complex programmable logic device;
40: fan;
S01˜S09: step

### DETAILED DESCRIPTION OF THE EMBODIMENTS

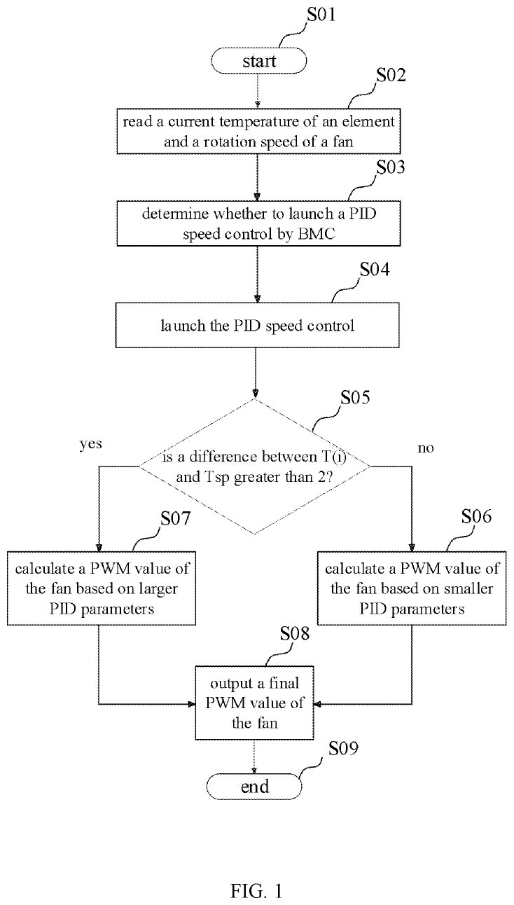

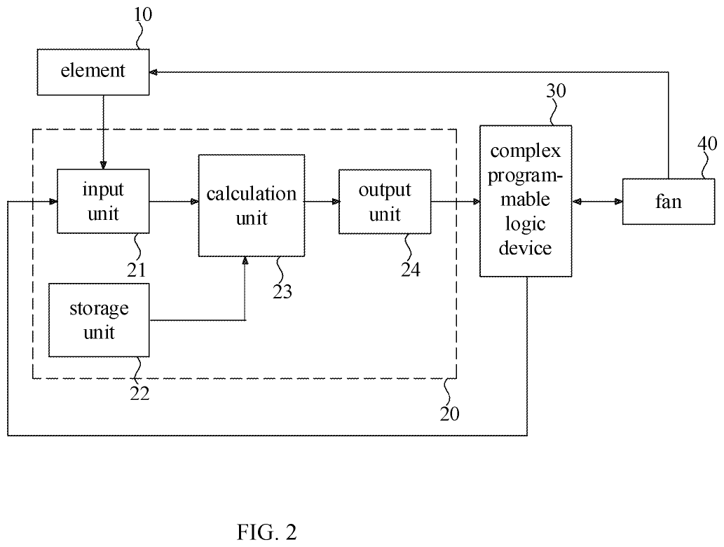

References may be made to FIG. 1 and FIG. 2. FIG. 1 shows a flow chart of a method for controlling total power consumption of a system by setting controller parameters based on temperature difference provided by a preferred embodiment of the present disclosure. FIG. 2 shows a schematic diagram of a structure for implementing a method for controlling total power consumption of a system by setting controller parameters based on temperature difference provided by a preferred embodiment of the present disclosure.

As shown in FIG. 1, a method for controlling total power consumption of a system by setting controller parameters based on temperature difference is disclosed by the present disclosure, such method is applied to a system at least including a heat-generating element, a fan, and a controller. The heat-generating element has a setpoint temperature Tsp. The controller may be, for example, a baseboard management controller (BMC) 20, which contains a Proportion Integration Differentiation (PID) controller, or a PID control value is stored in a storage unit 22 of the BMC 20 and is for calculation by a calculation unit 23. The heat-generating element may be, for example, an element 10 shown in FIG. 2, which generally refers to an element that can generates heat, such as a central processing unit (CPU) or a graphics processing unit (GPU).

The method of the present disclosure includes: first, starting a test process of an experiment and setting a controller with a first control parameter and a second control parameter (Step S01); then, reading a current temperature T(i) of element 10 and a rotation speed of fan 40 by a controller (Step S02); next, determining, by the controller, whether to launch a PID speed control strategy (Step S03); if determination result is positive, launching the PID speed control strategy (Step S04).

The aforementioned PID speed control, which stands for “proportional, integral, derivative control”, has PID control values that include a proportional coefficient Kp, an integral coefficient Ki, and a derivative coefficient Kd. This is a commonly used control strategy for fan 40, which is usually launched during a loading pressurization test, with an objective to quickly adjust an appropriate rotation speed of fan 40 to meet a temperature control requirement of element 10.

Further, the controller compares the current temperature T(i) with the setpoint temperature Tsp, for example, by calculating whether a difference between the current temperature T(i) and the setpoint temperature Tsp is greater than 2 (Step S05). Reasons for using this way for calculation to perform determination, and explanations for related content may be found in subsequent description.

If it is determined that the difference between the current temperature T(i) and the setpoint temperature Tsp is not greater than 2, that is, the difference is smaller than or equal to 2, which means the difference between the current temperature T(i) and the setpoint temperature Tsp is relatively small, the controller performs calculation using the first control parameter. That is, the controller calculates a pulse-width modulation value (PWM in abbreviation) of fan 40 using relatively small parameters of the PID control values (Step S06), and outputs the PWM value as a final current PWM value PWM(i) of fan 40 (Step S08). Thus, a feedback control is provided to fan 40 by the controller to control the total power consumption of the system.

If it is determined that the difference between the current temperature T(i) and the setpoint temperature Tsp is greater than 2, that is, when the difference between the current temperature T(i) and the setpoint temperature Tsp is relatively large, the controller calculates a PWM value of fan 40 using the second control parameter. That is, the controller calculates a PWM value of fan 40 using relatively large parameters of the PID control values (Step S07), and outputs the PWM value as a final current PWM value PWM(i) of fan 40 (Step S08). Thus, a feedback control is provided to fan 40 by the controller to control the total power consumption of the system. The experiment is ended (Step S09).

It should be particularly noted that description of a way for calculating the PWM value of fan 40 using the PID speed control strategy by the controller is as follows. The controller obtains a current PWM value PWM(i) based on a PWM value at a previous moment PWM(i−1) of the fan 40 and a PWM difference value ΔPWM(i) of the fan 40, that is, PWM(i) is calculated according to the following formula: PWM(i)=PWM(i−1)+ΔPWM(i). A specific way of calculating the PWM difference value ΔPWM(i) of fan 40 is accomplished according to the following formula: ΔPWM(i)=Kp*[e(i)−e(i−1)]+Ki*e(i)+Kd*[T(i)−2*T(i−1)+T(i−2)], where e(i)=T(i)−Tsp; T(i) is a temperature of element 10 at an i-th moment, that is, a temperature at a current moment; Tsp is a setpoint temperature for safe operation of element 10; and Kp, Ki, and Kd are PID control values stored in baseboard management controller 20, which are a proportional coefficient, an integral coefficient, and a differential coefficient respectively. When a difference between the current temperature T(i) and the setpoint temperature Tsp is relatively small, corresponding PID values are substituted as the first control parameter into calculation to obtain the current PWM value PWM(i). When the difference between the current temperature T(i) and the setpoint temperature Tsp is relatively large, corresponding PID values are substituted as the second control parameter into calculation to obtain the current PWM value PWM(i). The first control parameter is smaller than the second control parameter.

Description of related hardware is presented as follows, and reference may be made to FIG. 2, which is a schematic diagram of a structure for implementing a method for controlling total power consumption of a system by setting controller parameters based on temperature difference provided by a preferred embodiment of the present disclosure. The above-mentioned PID speed control strategy in the present disclosure is programmed into the baseboard management controller 20, and a specific control logic is as follows. The baseboard management controller 20 communicates with element 10 and a complex programmable logic device 30 (CPLD in abbreviation). An input unit 21 of the baseboard management controller 20 reads a temperature of element 10, a rotation speed of fan 40, and other information. A heat dissipation strategy (including a PID speed control strategy) stored in a storage unit 22 of the baseboard management controller 20 along with the above-mentioned information read by the input unit 21 are transmitted to a calculation unit 23 of the baseboard management controller 20. The calculation unit 23 determines whether the overall system platform is in a normal working state to decide whether to launch a PID speed control and a way of calculation in case of launching the PID speed control, and so forth. A calculated PWM difference value ΔPWM(i) of fan 40 is further transmitted as a fan control instruction to CPLD 30 by an output unit 24 of the baseboard management controller 20. The CPLD 30 further transmits the fan control instruction, which is transmitted by the baseboard management controller 20, to the fan 40. The fan 40 may determine whether and how to adjust its speed according to the fan control instruction sent by the CPLD 30, eventually completing a control of the fan 40 by the baseboard management controller 20. Additionally, the fan 40 transmits a fan signal, which includes information such as rotation speed, to the CPLD 30, and the CPLD 30 transmits its feedback to the input unit 21. Therefore, change in the rotation speed of fan 40 may cause a change in the temperature of element 10, which further counter reacts on the control by the baseboard management controller 20, achieving a bidirectional interaction between the temperature of element 10 and the rotation speed of fan 40.

For the test of the experiment, a specific loading pressure testing software is used to conduct the test of the experiment, which is particularly used for a graphics processing unit of the overall server system. During the experiment, power consumption of the graphics processing unit is momentarily halved and then quickly restored to full power, i.e., the power consumption is rapidly decreased and then rapidly increased, resulting in a rapid decrease followed by a rapid increase in temperature of the graphics processing unit. However, since both a heat dissipation risk point and a control point of fan 40 under a pressured loading condition are on the graphics processing unit, that is, the graphics processing unit under the pressured condition is the only element determining a rotation speed of fan 40, the graphics processing unit causes drastic fluctuations in the rotation speed of fan 40 at the end and beginning of each cycle.

Since the temperature of the graphics processing unit is closely related to its power consumption of the graphics processing unit, and the temperature of the graphics processing unit needs to be read before the rotation speed of fan 40 is adjusted, there is a certain delay in a response of the rotation speed of fan 40 to the power consumption of the graphics processing unit. This delay inevitably results in excessive adjustment of the rotation speed of fan 40, causing peaks in both the rotation speed of fan 40 and the power consumption, leading to peaks in the total power consumption of the system.

Based on the above-mentioned analysis, in order to reduce an impact of the graphics processing unit on the rotation speed of fan 40 during a process from an end to a restart of each cycle such that a goal of controlling the total power consumption of the overall system may be achieved, the following PID control strategy is proposed by the present disclosure: two different sets of parameters of PID control values are set according to a difference between a current temperature T(i) of the graphics processing unit and a setpoint temperature Tsp of the graphics processing unit for safe operation. When T(i)−Tsp≥−2 and T(i)−Tsp≤2, parameters of the PID control values corresponding to the smaller first control parameter are used, such as 2, 0.2, and 0.1. When T(i)−Tsp>2, parameters of the PID control values corresponding to the larger second control parameter are used, such as 3, 0.5, and 0.1. The present disclosure is advantageous that when the temperature of the graphics processing unit approaches its setpoint temperature Tsp, parameters of the PID control values are set to be relatively small (i.e., the first control parameter is adopted), making the rotation speed of fan 40 change slowly, which facilitates the rotation speed to stabilize rapidly. When the temperature of the graphics processing unit deviates relatively significantly from the setpoint temperature Tsp, the parameters of the PID control values are set to be relatively large (i.e., the second control parameter is adopted), making the rotation speed of fan 40 change quickly, which facilitates rapid reduction or increase in the rotation speed of fan 40, timely response to drastic changes in the temperature of the graphics processing unit, and avoidance of an out-of-range adjustment caused by a response delay of fan 40, thereby achieving a goal of reducing the maximum rotation speed of fan 40 and the total power consumption of the overall system.

By setting two different sets of parameters of the PID control values, a larger PWM difference Δ PWM(i) may be calculated when the temperature of the graphics processing unit rises relatively rapidly, allowing the rotation speed of fan 40 to be faster; and a smaller PWM difference Δ PWM(i) may be calculated when the temperature of the graphics processing unit rises relatively slowly, allowing a change in the rotation speed of fan 40 to be smaller. By using the above-mentioned strategy, an over-adjustment of fan 40 caused by rapid temperature change in the graphics processing unit may be avoided, thereby avoiding peaks to appear in the power consumption of the overall system and allowing a transient power consumption to be reduced below 900 W.

The present disclosure is applicable when the graphics processing unit is in a heating phase, and the temperature of the graphics processing unit rises rapidly after the loading is pressurized, which may even exceed 2° C. and reach 7° C. By using the strategy of the present disclosure, a larger rotation speed of fan 40 can be provided during the heating phase, which facilities to slow down a rise in the temperature of the graphics processing unit, thereby reducing a power consumption of fan 40 and a maximum total power consumption of the overall system.

A final result of the experiment shows that power consumption of the graphics processing unit during a cycle first decreases rapidly and then increases rapidly, causing all of the temperature of the graphics processing unit, the rotation speed of fan 40, the power consumption of fan 40, and the total power consumption of the overall system to decrease rapidly and then increase rapidly. Therefore, an effective PID control strategy is proposed by setting two different sets of control parameters to reduce the maximum rotation speed of fan 40 and the power consumption of fan 40, thereby achieving a goal of reducing the maximum transient total power consumption of the overall system and meeting the requirements of avoiding power consumption peaks.

It should be particularly noted that a key point of the above-mentioned strategy is the control strategy method, and the exemplified detailed PID control parameters, such as contents of the first control parameter and second control parameter, are not unique and there may still be room for further optimization and improvement. When changes occur to a wind guide cover, to the model and installation manner of the graphics processing unit, or to machine configuration and the like, values of relevant PID control parameters may need to be adjusted accordingly, yet the control strategy method remains valid. In addition, the PID control parameters can also be further adjusted and optimized according to changes in requirements, with the key point to achieve a goal of reducing a maximum rotation speed of fan 40 and a maximum total power consumption of the overall system through the strategy of the present disclosure.

In addition, it should be noted that although the above-mentioned strategy is based on an experiment result obtained from a pressure testing software which conducts actual loading pressurization on the graphics processing unit, the strategy can still be applied to other configurations of overall system and system platform that have severe fluctuations in power consumption and strict requirements for total power consumption of the overall system.

After conducting actual testing on the graphics processing unit using a loading pressure testing software, it is found that power consumption of the graphical processor first decreases rapidly and then increases rapidly, causing quick decreasing and then quick increasing of the temperature of the graphics processing unit, the rotation speed of fan 40, the power consumption of fan 40, and the total power consumption of the overall system. Therefore, an effective control strategy is provided by the present disclosure, which has the following advantages.
1. Rotation speed of fan 40 can be adjusted based on a temperature of element 10, such as a graphics processing unit, with features including fast response speed, high control accuracy, and an ability to achieve stable control quickly.
2. Two different sets of parameters of the PID control values are set according to a difference between the current temperature T(i) and a setpoint temperature Tsp of element 10, which effectively reduces the maximum power consumption of fan 40 and the total power consumption of the overall system.
3. A power consumption curve of the overall system is relatively flat, and does not contain drastic power consumption peaks, which leads to a small impact on power supply equipment and is conducive to extending life of the equipment.
4. The control strategy only requires some adjustments to be made in speed control instruction of the baseboard management controller 20, with low alteration difficulty and low alteration costs.

In view of the above, since the method for controlling total power consumption of system by setting controller parameters based on temperature difference provided by the present disclosure is a method for controlling total power consumption of the system which uses two different sets of control parameters and compares a temperature difference to determine which set of control parameters to use, the present disclosure can effectively achieve a more stable total power consumption of the system.

The above-mentioned preferred embodiments are illustrated in the hope that features and spirits of the present disclosure are described more clearly, yet the scope of the present disclosure shall not be limited by using the above-mentioned preferred embodiments being disclosed. On the contrary, the objective is to cover various alternations and equivalent arrangements within the intended scope of the present disclosure.

What is claimed is:

1. A method for controlling total power consumption of a system by setting controller parameters based on a temperature difference, which is applied to a system at least comprising a heat-generating element, a fan, and a controller, the heat-generating element having a setpoint temperature Tsp, wherein the method comprises:
setting the controller with a first control parameter and a second control parameter;
reading, by the controller, a current temperature T(i) of the heat-generating element; and
comparing, by the controller, the current temperature T(i) and the setpoint temperature Tsp to determine whether a feedback control is provided to the fan by the controller based on the first control parameter or based on the second control parameter such that the total power consumption of the system is controlled.

2. The method of claim 1, wherein the comparing the current temperature T(i) and the setpoint temperature Tsp comprises:
when a difference between the current temperature T(i) and the setpoint temperature Tsp is relatively small, using the first control parameter; when the difference between the current temperature T(i) and the setpoint temperature Tsp is relatively large, using the second control parameter.

3. The method of claim 2, wherein the first control parameter is smaller than the second control parameter.

4. The method of claim 2, wherein when the difference between the current temperature T(i) and the setpoint temperature Tsp is smaller than or equal to 2, using the first control parameter; when the difference between the current temperature T(i) and the setpoint temperature Tsp is greater than 2, using the second control parameter.

5. The method of claim 1, wherein the controller is a baseboard management controller.

6. The method of claim 1, further comprising a step of determining, by the controller, whether to launch a PID speed control strategy.

7. The method of claim 6, wherein the first control parameter and the second control parameter owned by the controller each comprise a proportional coefficient, an integral coefficient, and a derivative coefficient.

8. The method of claim 7, wherein the proportional coefficient, the integral coefficient, and the derivative coefficient of the first control parameter are 2, 0.2 and 0.1 respectively.

9. The method of claim 7, wherein the proportional coefficient, the integral coefficient, and the derivative coefficient of the second control parameter are 3, 0.5 and 0.1 respectively.

10. The method of claim 1, wherein the providing, by the controller, a feedback control to the fan based on the first control parameter or based on the second control parameter comprises:
calculating, by the controller, a current pulse-width modulation value of the fan and outputting the current pulse-width modulation value.
